(19) United States
(12) Patent Application Publication
(10) Pub. No.: US 2011/0159165 A1
(43) Pub. Date: Jun. 30, 2011

(54) Method of Producing Acid Stable Protein Products and Products so Produced

(75) Inventors: Lalitha Nair, Centurion (ZA); Ramsamy Annamalay Nair, Centurion (ZA)

(73) Assignee: NAIRSONS FLAVOURHOUSE CC, Centurion (ZA)

(21) Appl. No.: 12/682,466

(22) PCT Filed: Aug. 8, 2008
(86) PCT No.: PCT/IB08/53488

§ 371 Date: Jul. 28, 2010

(30) Foreign Application Priority Data
Oct. 10, 2007 (ZA) 2007/08646

(51) Int. Cl. A23C 19/00; A23C 9/152; A23L 2/00; A23J 1/00

(52) U.S. Cl. 426/582; 426/580; 426/583; 426/590; 426/599; 426/654; 426/656

(57) ABSTRACT

This invention relates to a method of producing powders and liquids containing milk proteins, which are stable in an acidic medium. In particular, the invention is concerned with a method of producing a powder which can be mixed with water, milk or juice to form a stable, acidified, high protein beverage. Moreover, the invention extends to a method of producing a carbonated, flavoured milk beverage or a carbonated, acidified flavoured milk beverage that is stable in an acidic medium. The invention also discloses methods of producing yoghurt style beverages and cream cheese by blending a stabilised acid component and a stabilised protein component to form an acidified protein component.

### BACKGROUND TO THE INVENTION

THIS invention relates to a method of producing powders and liquids containing milk proteins, which are stable in an acidic medium. In particular, the invention is concerned with a method of producing a powder which can be mixed with water, milk or juice to form a stable, acidified, high protein beverage. Moreover, the invention extends to a method of producing a carbonated, flavoured milk beverage or a carbonated, acidified flavoured milk beverage that is stable in an acidic medium.

Various so-called “ready-to-drink” acidified milk beverages, for example those sold in South Africa under the trade names Tropika™ and Cabana™ are well known in the beverage market. These ready-to-drink acidified milk beverages have relatively low pH values (typically between pH 3.5 and 4.3) due to the fact that their acidic character provides a pleasant and refreshing taste.

Milk protein micelles comprise mainly of three components, namely whey protein, casein protein and calcium phosphate. When the pH value of milk is lowered, the acidic and basic groups of proteins in the milk are neutralised. At the pH value at which the positive charge on a protein equals exactly the negative charge, the net total charge of the protein is zero. This pH value is called the “isoelectric point” of the protein. For casein this pH value is about 4.6, and is the pH value at which casein is no longer in suspension in milk. If the milk pH is lowered towards its isoelectric point or below that, such as when an acid is added to the milk, or when acid-producing bacteria is allowed to grow in the milk, the casein precipitates out of the milk and starts to curdle.

In order to overcome the problem of casein precipitating at pH values lower than 4.6, producers of acidified milk beverages make use of stabilisers such as high methoxyl pectin (pectin) and sodium carboxymethylcellulose (CMC) to deter casein from precipitating and curdling when an acid is added to the milk. In conventional methods a protein component (e.g. milk), which comprises casein, and a stabiliser is provided. In this protein component the casein and the stabiliser carry a negative charge. When the protein component is acidified to below the isoelectric point, the charge of the casein is reversed to become positive, in turn causing attraction between the negatively charged stabiliser and the now positively charged casein. The new net overall charge of the casein and stabiliser is negative, consequently producing electrostatic repulsion in solution, thus preventing the casein from falling out of solution.

One drawback of this conventional method is that the protein concentration of such products is very low. In fact, it only allows for a maximum of about 1% protein per litre product in solution, i.e. about 10 gram proteins per 1000 ml product. Moreover, this protein concentration can only be achieved with high pressure homogenisation to maintain proper stabilisation. Using traditional methods to produce an acidified milk beverage having greater protein content generally leads to synerisis and almost always of the product not having good freeze thaw stability.

Another drawback associated with conventional technologies, especially when undenatured milk is used, is wheying off of the liquid and a chalkiness that remains on the tongue and in the mouth after consumption of the product.

Yet a further problem associated with conventional methods of producing liquid acidified milk beverages is excess foaming, which tends to occur during acidification of undenatured milk protein products. In products which contain relative high amounts of undenatured milk proteins, the amount of stabiliser used must be increased, which in turn leads to higher viscosity levels in the product being produced. Also, the foam produced tends to trap air in the slurry which is difficult to de-aerate. It is well known that such trapped air, if containing free oxygen, will generally lead to the product produced becoming spoiled due to the fact that micro-organisms, such as bacteria, yeasts and moulds, grow therein.

Another problem associated with conventional methods of producing acidified milk beverages, especially those having a low viscosity and higher protein content such as drinking yoghurt, is that in order to guarantee protein stabilisation, the pH must be between 3.5 and 4.5. As mentioned before, the pH plays an important role in determining product taste. Since a pH outside of this range result in protein instability, food producers have no flexibility to manipulate the pH and hence the product taste. It would, for example, be advantageous to be able to produce milk beverages that are less tart, i.e. having a pH closer to 4.6, at which pH the casein is the least soluble in solution, as mentioned above.

Also, hitherto it has been impossible to produce carbonated milk drinks, carbonated acidified milk drinks, acidified milk drinks having a protein content greater than 1%, or acidified powdered milk beverages that are stable and have all their proteins in a micellar form.

### SUMMARY OF THE INVENTION

According to the present invention there is provided a method of producing an acidified protein component, comprising the steps of—
providing a protein component;
providing a stabilised acid component comprising an acid and an amount of a first stabiliser formulation dissolved in water, the amount of the first stabiliser formulation being of a sufficient amount to deter the occurrence of any unbound hydrogen ions in the acid component; and
blending the stabilised acid component with the protein component to form the acidified protein component.

The method includes the step of stabilising the acid by providing an amount of the first stabiliser formulation that is sufficient to deter the occurrence of any unbound hydrogen ions in the acid component. In particular, the method provides adding between 1.68 grams and 4.00 grams, and preferably 1.92 grams, of first stabiliser formulation to one liter of unstabilised acid comprising a hydrogen ion concentration of between 10^{-2.50} mol/L and 10^{-2.70} mol/L, and preferably 10^{-2.53} mol/L, to produce a stabilised acid component with a final hydrogen ion concentration of between 10^{-2.71} mol/L and 10^{-3.10} mol/L.

The stabilised acid component may have a pH of more than 2.70, and preferably a pH of between 2.71 and 2.94. The method may be characterised therein that it is not necessary to blend a buffer into the stabilised acid component after the desired pH has been achieved.

The first stabiliser formulation may comprise a hydrocolloid polysaccharide stabiliser gum. The polysaccharide stabiliser gum may be selected from the group comprising microcrystalline cellulose, jellan gum, alginates, carrageenan, guar gum, locust bean gum, xanthan gum, pectin and cellulose gums. Preferably, the polysaccharide stabiliser gum is sodium carboxymethylcellulose (CMC). In a preferred form of the invention the polysaccharide stabiliser gum has a low molecular weight. Moreover, the polysaccharide stabiliser gum may be anionic.

The acid may be a food-grade acid such as citric acid monohydrate, although it will be appreciated that any acid or acid producing compound that is capable of lowering the pH may be used, such as phosphoric acid, lactic acid, malic acid, ascorbic acid, tartaric acid or glucono delta lactone. In one embodiment of the invention, the acid is fruit juice or vegetable juice or a combination thereof.

The protein component may include an undenatured liquid or powder protein in micellar form dissolved in water. “Undenatured protein in micellar form” will be interpreted to mean a protein in which the whey and casein proteins are in their unadulterated native state together with its colloidal calcium phosphate. Typically the protein component comprises milk based proteins. Particularly, the milk based proteins comprises mammalian milk in the form of liquid milk, evaporated milk, milk powders, milk protein concentrates and/or milk protein isolates.

Alternatively, the protein component may comprise soy based proteins such as soy milk powder, soy protein concentrates, soy protein isolates or any another protein or protein hydrolysates from a vegetable or animal origin that is insoluble at its isoelectric point, exist in a micellar form with an organic salt or polyphosphate, and is colloidal in solution with a cation, notably calcium.

The protein component may be mixed with an amount of a second stabiliser formulation dissolved in water or a liquid protein component to produce a stabilised protein component, which may be blended with the stabilised acid component to form the acidified protein component. The amount of the second stabiliser formulation may be of a sufficient amount to deter hydrogen ions becoming unbound from the stabilised acid component and being attracted to protein micelles in the acidified protein component. In order to maximise the negative charge on the protein micelle and to eventually achieve maximum protein micelle protection, the ratio between the protein component and the second stabiliser component must be such that maximum precipitation of the protein micelle from the stabilised protein component is achieved.

The second stabiliser formulation is an anionic, hydrocolloid, polysaccharide stabiliser gum of low molecular weight. The polysaccharide stabiliser gum may be selected from the group comprising carrageenan, gellan gum, ghatti gum, agar, xanthan gum, tragacanth gum, alginates, pectin and cellulose gums. In particular, the polysaccharide stabiliser gum may be a linear polysaccharide

The polysaccharide stabiliser gum of the second stabiliser formulation should include carboxyl groups. In particular, the polysaccharide stabiliser gum is characterised therein that at least certain of its three hydroxyl groups per monosaccharide unit is substituted with a carboxyl group to make the polysaccharide stabiliser gum ionic. More particularly, the polysaccharide stabiliser gum may be sodium carboxymethylcellulose (CMC).

The ratio between the protein component and the second stabiliser formulation in the stabilised protein component may be between 17:1 and 5.666:1, and preferably may be 8.5:1.

The protein component and the second stabiliser formulation may undergo high shear mixing. Preferably the protein component and the second stabiliser formulation are subjected to a single stage or a two stage homogenisation step to form the stabilised protein component.

The method may include blending a buffer into the stabilised protein component after high shear mixing and homogenisation.

The stabilised protein component may be added into the stabilised acid component under high shear mixing conditions to form the acidified protein component. The acidified protein component may have a pH of between 3.1 and 6.5. The acidified protein component may be dosed with an antifoaming agent. In the acidified protein component, the protein micelle is protected due to steric hindrance and the final pH is dependent on protein micelle concentration.

The method may be characterised therein that the absence of additional foam being formed during the addition of the stabilised protein component to the stabilised acid component serves as confirmation thereof that the acid: stabiliser ratio in the stabilised acid component and the protein: stabiliser ratio in the stabilised protein component is in the correct proportions. The reason for this is that steric protection of the protein micelles prevents hydrogen ions from dissolving the phosphates into solution and thereby destabilising the protein micelles, which eventually produces additional foam.

The applicant postulates that the hydrogen ions in the stabilised acid component and the acidified protein component are utilised in two ways. Typically a minor amount of hydrogen ions will bond ionically with the carboxyl groups of the stabiliser formulation, rendering it neutral at that point. The balance of hydrogen ions, specifically in the form of hydronium ions (H₃O⁺), will bond electrostatically with the available carboxyl groups of the stabiliser formulation, rendering it positive and leaving no hydronium ions unbound, thus forming a positively charged hydronium ion stabiliser complex at the point of attraction. The positively charged hydronium ion stabiliser complex will be attracted to the now more negatively charged protein micelle in a first stage of steric protection, leading to a second stage of steric protection. For optimum protein micelle suspension, the second stage of steric protection is required, i.e. all the negatively charged protein micelles in the first stage of steric protection must bond electrostatically with the hydronium ion stabiliser complex. The balance of hydronium ion stabiliser complex, which does not bond with the protein micelles, is colloidal in solution and provides the necessary acidity.

The method may include the step of blending the stabilised acid component with the stabilised protein component within no more than 1 hour of the acid and dissolved first stabiliser formulation being added together, so as to ensure proper stabilisation of the protein micelle in the acidified protein component.

The acidified protein component may be subjected to a single stage or a two stage homogenisation step.

Preferably the stabilised protein component and the stabilised acid component include water during mixing. More preferably the water may be deionised filtered water.

The method may include the step of drying the acidified protein component to form an acidified protein powder. The acidified protein component may be dried by way of spray drying. The dried acidified protein powder may have a particle size of greater than 100 micrometer and may be agglomerated for better solubility. Drying of the acidified protein component must be done in such a way that there is no dehydration of the hydronium ions during the spray drying process or at least dehydration must be kept to a minimum, such that the unbound dehydrated hydronium ions (i.e. the hydrogen ions) can be buffered by the buffer, and the electrostatic attraction between the carboxyl groups and the hydronium ions is maintained.

Typically, the moisture content of the spray-dried acidified protein powder is between 5% and 15%, and preferably between 10% and 12%.

The acidified protein powder may contain a free-flowing agent, which is characterized in not having a dehydrating effect on the hydronium ions. The free-flowing agent may be silicon dioxide.

The spray drying may have an inlet temperature of between 110° C. and 160° C., preferably between 150° C. and 160° C., for optimum acidified protein powder product yield.

In an embodiment of the invention the protein component is kept hydrated in the form of a slurry.

The method may include the further steps of—
drying the stabilised acid component to form a stabilised acid powder, and
dry-blending the stabilised acid powder with the acidified protein powder to form an acid-protein powder blend.

The method may include the step of adding a bulking agent to the stabilised acid component before drying it. The bulking agent may be selected from the group comprising hydrolysed starches, sugars and maltodextrin. Preferably, the bulking agent is maltodextrin.

The stabilised acid component may be dried by means of spray-drying.

The stabilised acid powder may not include a buffer.

In one form of the invention, the acid-protein powder blend may be added to water to form a drinking yoghurt style beverage or a ready-to-drink acidified milk beverage.

In an alternative form of the invention the method provides the steps of blending the stabilised acid powder with a pre-hydrated CMC powder, and adding the blend into a protein component, such as milk, to produce a yoghurt style beverage. To make pre-hydrated CMC powder, CMC is wetted and re-dried such that it has a moisture content of between 14% and 17%. The pre-hydrated CMC powder may be agglomerated for increased solubility.

The method also may provide the step of encapsulating the stabilised acid powder. Particularly, the encapsulation is such that there is at least 10 seconds delay before the stabilised acid powder starts to dissolve, so as to allow the pre-hydrated stabiliser to first dissolve into the protein component, thus allowing its carboxyl groups to adsorb onto the protein micelles.

In yet a further form of the invention, the method provides the steps of blending a milk protein component with a second stabiliser formulation in the form of CMC under high shear conditions to form a stabilised protein component, and blending the stabilised protein component with the stabilised acid powder to produce cream cheese. The cream cheese so produced may be characterised therein that it includes its whey proteins.

In yet another form of the invention, the method provides the steps of providing a stabilised acid component comprising an acid in the form of fruit or vegetable juice or a combination thereof, and a first stabiliser formulation in the form of pre-hydrated CMC powder, and blending the stabilised acid component with one of either an acidified protein powder, acidified protein component, or a stabilised protein component to form a so-called “smoothie”. A smoothie is typically a smooth thick drink made from fresh fruit and/or fruit juice, which is blended with yoghurt, ice cream or milk. A smoothie so produced may be characterised therein that it includes casein milk proteins.

The method may include the further steps of adding free flowing agent to the stabilised acid powder and to the acidified protein powder to prevent it from drawing moisture from atmospheric air.

The method may include the further steps of providing a stabilised acid component comprising a carbonic acid, which is formed by bubbling carbon dioxide through an amount of a first stabiliser formulation that has been dissolved in water, and either adding a stabilised protein component into the stabilised acid component under high shear to form a carbonated acidified protein beverage, or alternatively adding an acidified protein component into the stabilised acid component under high shear to form a carbonated acidified protein beverage.

The carbonic acid may have a pH exceeding 2.7, preferably exceeding 2.87, and more preferably equal to or greater than 2.94. The stabilised acid component may not include a buffer.

### BRIEF DESCRIPTION OF THE DRAWINGS

The invention will now be described in more detail, by way of non-limiting examples only, and with reference to the accompanying drawings, wherein—

FIG. 1 provides a diagrammatic overview of the core components of the invention and the method in which they are produced.

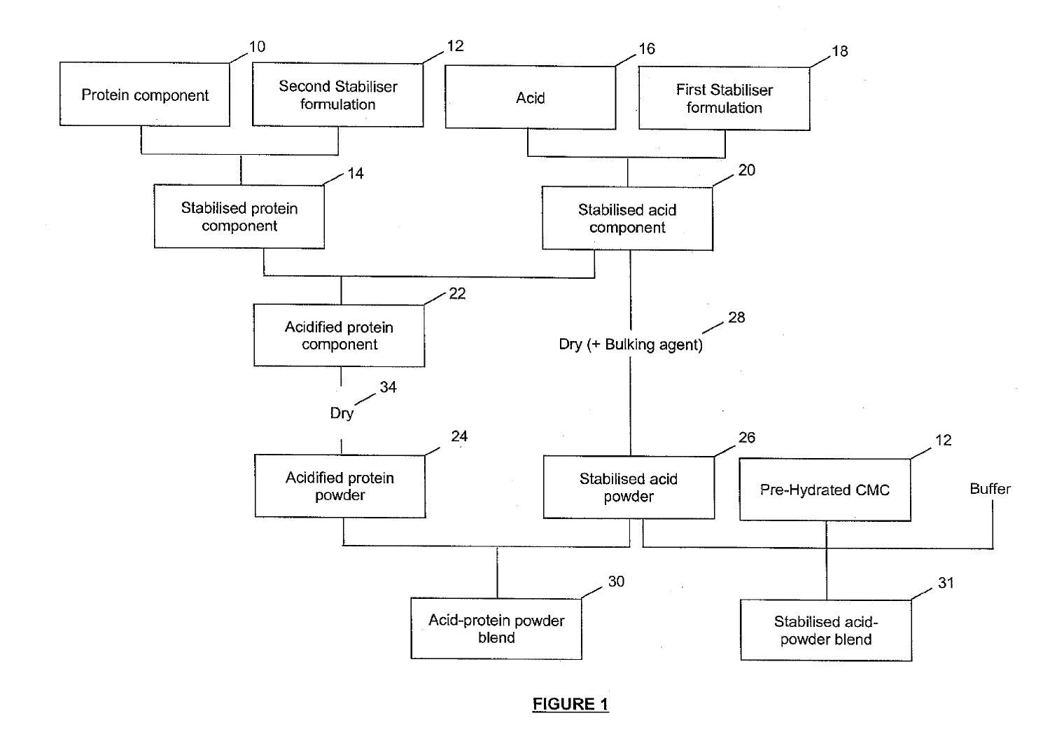

FIG. 2 provides a more detailed diagrammatic representation of the method of producing the acidified protein component and an acidified protein powder, which are used as core components for other methods of the invention, as well as for producing drinking yoghurt and acidified milk beverages.

FIG. 3 provides a diagrammatic representation of an alternative method of producing drinking yoghurt and acidified milk beverages.

FIG. 4 provides a diagrammatic representation of yet a further method of producing a yoghurt style beverage.

FIG. 5 provides a diagrammatic representation of the method of producing cream cheese.

FIG. 6 provides a diagrammatic representation of the method of producing a smoothie.

FIG. 7 provides a diagrammatic representation of the method of producing a carbonated acidified protein beverage.

### DESCRIPTION OF THE ILLUSTRATED EMBODIMENTS

In this description like reference numerals will be used to indicate like components in the various methods of the invention described below.

In conventional processes used for preparing acidified milk beverages, phosphates in colloidal calcium phosphate in milk are dissolved during the acidification process. The addition of acid to the milk results in the eventual reversal of the charge of the casein molecule in the milk from negative to positive. It is known that the reaction between the colloidal calcium phosphate and the acid eventually leads to the protein molecule becoming neutral and even having its charge reversed after further acidification. This acidification process is the cause of excess additional foam produced in acidified milk beverages using traditional methods. Using this method of reversing the charge of the casein to obtain eventual stabilisation has a drawback, since the amount of protein is low, i.e. only about 1% in solution, and almost always requires high pressure homogenisation.

The present invention proposes to address the problem of additional unwanted foam and limited pH ranges (i.e. from about 3.5 to 4.5), and also attempts to increase the protein content by ensuring that the protein material used is properly hydrated with a correct proportion of stabiliser and then acidified with an acid-stabiliser component which in itself is in the correct proportion.

Using the correct proportion of stabiliser in a milk base, it is believed that some or all of the carboxyl groups of the stabiliser will be adsorbed to the calcium bridges of the casein micelle, thereby increasing the overall negative charge of the protein micelle. It is at this point that the protein micelle is precipitated out of solution and consequently leads to optimum protein micelle protection. If all of the calcium bridges are sufficiently protected, the casein will not be susceptible to sedimentation and flocculation only when brought into contact with an acid stabiliser mixture in the correct proportion.

The applicant believes that when, for example, citric acid is used in the correct proportion with a stabiliser during acidification, the negatively charged stabiliser is attracted by way of its carboxyl groups to the positively charged hydronium ions in solution. The hydronium ions are utilized in two ways by the stabiliser. According to the first way, the stabiliser has the ability to consume hydrogen ions from the solution, since the pH of the solution is increased when the same amount of acid is used with greater amounts of stabiliser by ionic bonding. Furthermore, the viscosity of the solution is decreased during acidification, probably making the gum less hydrophilic where the hydrogen ions bond with the carboxyl groups of the stabiliser.

According to the second way, some of the carboxyl groups bond electrostatically with the hydronium (H₃O⁺) ions, thereby promoting an acidic pH. This will cause the stabiliser to have positive regions. Due to this bonding, it is believed, the carboxyl groups of the stabiliser in the acid stabiliser mixture will leave no available hydrogen ions to react with the calcium phosphate when the milk and stabiliser are combined with the acid and stabiliser mixture, thus deterring the occurrence of additional unwanted foam. Furthermore, during combination of the two mixtures it is believed that some of the positively charged regions of the stabiliser adsorbs onto the now more negatively charged protein micelle, thus forming a protective shield for the protein micelle, resulting in steno protection. It is this protective shield or steric protection that prevents the hydronium ions from unbinding itself from the carboxyl groups and dissolving the phosphate into solution, thus maintaining stability.

However, should the protein micelle not have sufficient amounts of the initial negative stabiliser to adsorb onto the calcium bridges, then hydronium ions will migrate from the carboxyl bonds in the stabilised acid component and dissolve the unshielded phosphate into solution, thereby destabilising the solution.

Also, should the protein micelle have sufficient amount of the initial negative stabiliser to adsorb onto the calcium bridges, but there is unbound hydronium ions in solution (i.e. it is not bound to the carboxyl groups), then the hydrogen ions will dissolve the phosphate into solution, thereby destabilising the solution by making the steric protection ineffective.

It is not fully understood at this stage, but it is postulated that perhaps the charge on the stabilised protein micelle after acidification is positive and produces positive repulsion in solution to suspend the protein micelles and create stability compared to traditional methods were negative repulsive forces is used to create stability and suspend the protein molecules.

Using the above technology, a stable mixture with little or no sedimentation and flocculation is guaranteed and also higher protein contents can be achieved without the product foaming. Also, a wider pH range is achieved since stability is not dependant on the proteins achieving a positive charge.

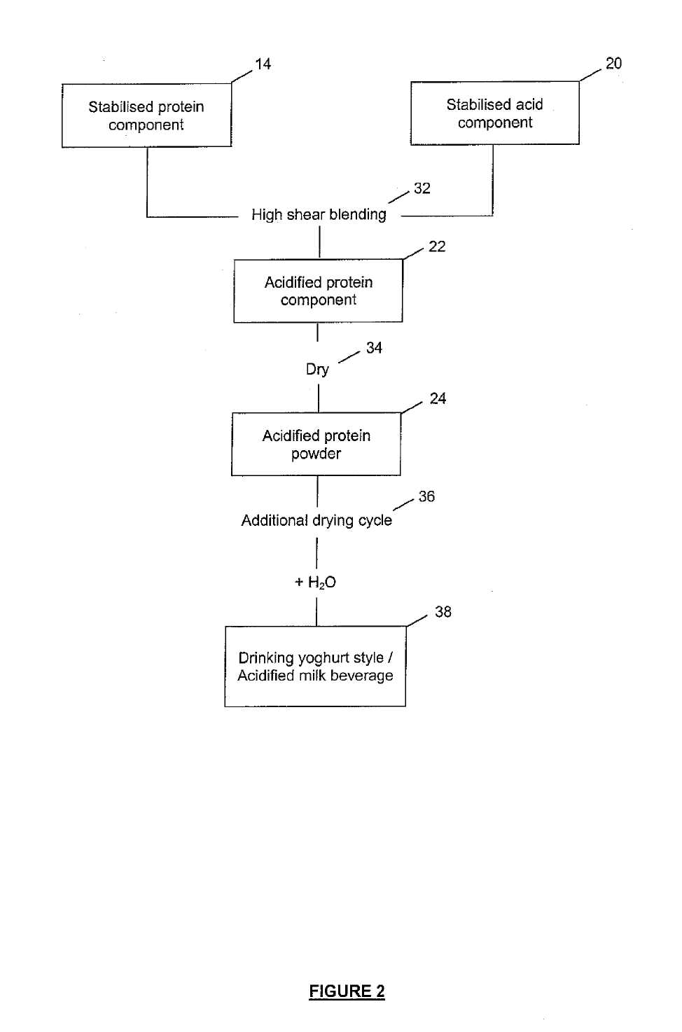

FIG. 2 provides a schematic representation of steps to be taken in a method of producing an acid stable protein product in accordance with the invention, in particular a liquid or a powder for an acidified protein component. Typical products which can be produced with this method of the invention include powdered and liquid protein beverages with different protein and pH levels having different viscosities. Typical examples are beverages and beverage concentrates, also including alcoholic types, condiments, frozen desserts, confectionary and even personal care cosmetics.

The first step in the method provides a stabilised protein component 14 in the form of a slurry. The stabilised protein component 14 comprises an undenatured milk protein 10, which is a protein in micellar form, and a second stabiliser formulation 12 that has been dissolved in deionised filtered water during high shear conditions. The stabilised protein component 14 includes a buffer in the form of tri-sodium citrate. Preferably the stabilised protein component 14 is homogenised before addition of the buffer by way of one or two stage homogenisation steps.

In this embodiment of the invention, skim milk powder is used as the protein component 10. It is, however, pointed out that various forms of protein materials could be used as the starting protein component. Protein components could, for example, include evaporated milk, milk powders, milk protein concentrates and milk protein isolates, or alternative proteins or protein hydrolysates, such as soy milk powder, soy protein concentrates, soy protein isolates, and caseinates derived from milk. These alternative proteins must be processed further into a micellar form to render it suitable for the claimed process.

The second stabiliser formulation 12 here comprises sodium carboxymethylcellulose (CMC). The purpose of the second stabiliser formulation 12 is to prevent casein in the stabilised protein component 14 from precipitating and curdling when exposed to an acid stabiliser blend.

The stabilised protein component 14 may be produced upstream of an evaporator in a dairy process, i.e. liquid skimmed milk 10 and the second stabiliser formulation 12 may be concentrated in the evaporator to form the slurry. Alternatively, the skimmed milk 10 and the second stabiliser formulation 12 could be produced downstream from the evaporator of the dairy process, i.e. the concentrated skimmed milk 10 can have the stabiliser formulation 12 mixed into it at this time. Typically, the stabilised protein component 14 is left to hydrate completely. Homogenisation of the slurry can be done in either 1 or 2 stages. Optionally the skimmed milk 10 could also be processed further using membrane ultra-filtration technology where a retentate is formed, such as milk protein concentrates or isolates, depending on the protein content required.

It is preferable that the stabilised protein component 14 is de-aerated and free from trapped air.

The next step of the method provides a stabilised acid component 20, also in the form of a slurry. The stabilised acid component 20 of this embodiment comprises a food grade acid 16 in the form of citric acid monohydrate, together with an amount of a first stabiliser formulation 18, in this case being CMC. It will, however, be readily appreciated that other acids could also be used, including phosphoric acid, lactic acid, malic acid, ascorbic acid, tartaric acid, glucono delta lactone, and fruit juice or vegetable juice. The first stabiliser formulation 18 serves the same purpose as the second stabiliser formulation 12 in that it will deter casein in the milk from precipitating and curdling when exposed to the citric acid. This is achieved by ensuring that the correct amount of acid 16 to first stabiliser formulation 18, as calculated below, are blended with the stabilised protein component 14.

The next step in the method comprises introducing the stabilised protein component 14 into the stabilised acid component 20 under high shear conditions 32 to form an acidified protein component 22. The reason for introducing the stabilised protein component 14 into the stabilised acid component 20, and not the other way around, is to prevent a sudden high viscosity of the mixture caused by the attraction of the now more negatively charged casein micelles and the positively charged hydronium ion stabiliser complex. It is pointed out that the high shear mixing in step 32 aids in proper mixing of the slurry. It is beneficial for the slurry to be homogenised.

It is further pointed out that the first stabiliser formulation 18 and the acid 16 of the stabilised acid component must be in appropriate ratios in order to prevent sedimentation and flocculation when the stabilised protein component 14 and the stabilised acid component 20 are combined. This aspect will be described below.

The stabilised acid component 20 should typically be left to rest or hydrate and be free from trapped air bubbles. The stabilised acid component 20 should further preferably be combined with the stabilised protein component 14 within a relatively short period of time after being produced, as a long delay could lead to flocculation when the two slurries, constituting the stabilised protein component 14 and the stabilised acid component 20, are combined. This is probably due to cross-linking of the first stabiliser formulation 18 in the stabilised acid component 20, whereby the positive and negative regions attract each other, thereby cancelling the charge and making it ineffective to stabilise the protein micelle in the second stage of steric protection in the acidified protein component 22. Typically the acidified protein component 22 could contain an anti-foaming agent.

It is pointed out that this step could be used for producing products having different viscosities and different protein levels for drinkable beverages. Step 32 could also include the addition of sweetening and flavouring agents and preservatives so that an end user can prepare an acidified milk beverage by simply reconstituting the acidified milk concentrate with the addition of water.

It is beneficial if the stabilised protein component 14 and the stabilised acid component 20 are mixed under vacuum in a high shear process vessel to avoid further de-aeration as explained above.

The slurry formed during step 32 should be properly de-aerated in order to prevent product spoilage and foaming when the formed concentrate is mixed with water.

The final step in the method comprises drying 34 the acidified protein component 22 to form an acidified protein powder 24. Typically, drying 34 will be effected with the use of a spray drying process.

It is pointed out that due to the high surface tension resulting when the dried particles constituting the acidified protein powder 24 are brought into contact with water, a consequence of the protein and stabiliser content, it is beneficial that the acidified protein powder 24 be agglomerated. This will facilitate dissolving of the acidified protein powder 24.

The final step could include a gentle multi-stage drying cycle 36 so that the acidified protein powder 24 produced does not sediment when dissolved in water. Inlet spray drying temperatures should not exceed 110° C., but due to economies of scale it may seem impractical to spray dry at these low inlet temperatures. Using higher inlet temperatures will typically produce an acidified protein powder 24 that will tend to sediment when dissolved in water.

Spray drying is a relative gentle process to dry food products due to the fact that the particles formed reach a maximum temperature in the order of 50° C. in the hot zone of the drying chamber. However, protein denaturing still occurs in the resulting product. It is believed that so-called “heat denaturing” occurs because of the spray particles' rapid loss of water, which in turn leads to dehydration of the hydronium ions, causing it to dissolve the phosphate, which will cause the protein micelle to destabilise and become insoluble. This will result in the eventual sedimentation when the acidified protein powder 24 is mixed with water.

To address this problem, it is preferred that the stabilised protein component 14 includes a buffer to buffer any dehydrated hydronium ions so that higher inlet temperatures, typically of the order of 160° C., can be utilised. Gentler drying will, however, typically be preferred. An example of a suitable buffer is tri-sodium citrate.

It is believed that during a rapid drying process, hydrogen ions in the form of dehydrated hydronium ions that were initially attracted to the carboxyl groups of the stabiliser formulations in the slurry phase will become free and available by the loss of water during the drying process. The hydrogen ions in turn will dissolve the phosphate, undermining the stability of the product and possibly neutralising or reversing the charge of the protein from negative to positive. When the dried powder is eventually rewetted in water for preparing a beverage, the destabilised casein micelle will flocculate and cause sedimentation.

Adding the sodium citrate buffer will buffer any hydrogen ions released during spray drying. When hydronium ions are dehydrated during the drying process, the now available positively charged hydrogen ions that were released from the carboxyl groups of the stabiliser formulations will be buffered by the negatively charged citrate ions, whilst (it is believed) the displaced sodium on will be attracted to the available carboxyl groups of the stabiliser. When the formed powders are then reintroduced into water, and for equilibrium to be reached, it is thought that the buffered hydrogen ions will dissociate from their citrate bonds, forming hydronium ions again and be attracted to the negatively charged carboxyl groups of the stabiliser by displacing the sodium ion again, thereby maintaining the original pH and also preventing the phosphate from being dissolved into solution and thereby maintaining stability.

This formed powder will not foam, sediment or flocculate after being dissolved in water. It is, however, imperative that the amount of sodium citrate not be allowed to fall below a specified dosage in order to prevent the occurrence of free hydrogen ions which would react with calcium phosphate. The acidified protein powder 24 is then added to water to form a drinkable yoghurt style beverage or a milk-juice type of beverage 38.

The method above can be described in more detail with reference to the following example. In order to prevent casein from precipitating, the correct ratio of the second stabiliser formulation 12 to protein component 10 must exist in the stabilised protein component 14. Also, the correct ratio of the first stabiliser formulation 18 to acid 16 must exist in the stabilised acid component 20, while the correct ratio of acid to buffer must exist in the acidified protein component 22.

The ratio for the second stabiliser formulation 12 and protein component 10 is from 1:17 to 1:5.666, and is preferably 1:8.5. The 1:17 ratio equates to 1 g CMC on a dry weight basis to 17 g protein in a dry weight basis. For a skim milk powder formulation this equates to 1 g CMC to 50 g skim milk powder. The more preferable 1:8.5 ratio equates to 1 g CMC on dry weight basis to 8.5 g protein in a dry weight basis. For a skim milk powder formulation this equates to 1 g CMC to 25 g skim milk powder.

The ratio of the CMC in the first stabiliser formulation 18 to the citric acid monohydrate 16 is from 1:1.096491, and preferably from 1:1.302083 on a dry weight basis in order to prevent flocculation when the stabilised protein component 14 and the stabilised acid component 20 are combined. In order to obtain different viscosities and pH values in different beverages, the amount of acid 16 to CMC 18 could vary, but the percentage of CMC to citric acid monohydrate must be such that the acid 16 is not greater than 1.096491 times the amount of first stabiliser formulation 18. Preferably the acid must not be greater than 1.302083 times the amount of the first stabiliser formulation 18 or more specifically the initial acid concentration to CMC is 10^{-2.53} mol/L:1.92 g CMC/L

The ratio of the acid 16 and the buffer is from 1:0.05, and preferably from 1:0.15. The 1:0.05 ratio equates to 1 g citric acid monohydrate on a dry weight basis to 0.05 g tri-sodium citrate on a dry weight basis. The 1:0.15 ratio on the other hand equates to 1 g citric acid monohydrate on a dry weight basis to 0.15 g tri-sodium citrate on a dry weight basis.

The ratio of the CMC 18 to acid 16 in the stabilised acid component 20 has been calculated on a trial basis to provide one approximate known value. Using this known value a formula can be derived using the equation for determining pH values, namely—

pH=−log₁₀[H⁺],

where [H⁺] is the concentration of H⁺ ions in moles per litre.

It is believed that this formula can be used as a guide to determine the approximate minimum stabiliser formulation required for the desired pH value in an acidified protein component 22 in accordance with this invention, specifically by measuring the pH of a one litre solution diluted with 2.5 g of citric acid monohydrate. The pH of this solution is approximately 2.53, which equates to 10^{-2.53} mol/L hydrogen ions. 2.5 g of citric acid monohydrate is used in combination with 1.92 g of stabiliser formulation. This equates to 10^{-2.53} mol/L hydrogen ions per 1.92 g stabiliser formulation used to effectively prevent flocculation and sedimentation when the stabilised protein component 14 is combined with the stabilised acid component 20.

With the use of the above values and using the pH value of the unstabilised acid component, it is possible to determine the minimum amount of stabiliser formulation on a dry weight basis which is required for the new unstabilised acid component. If the new pH of the mixture is 5, using the formula pH=−log₁₀[H⁺], the amount of stabiliser formulation required can be used by first determining the H⁺ concentration in solution, namely:

$$5 = - {log}_{10} [ {H}^{+} ]$$

$$\begin{matrix}{H}^{+} = {10}^{- 5} \\ = {10}^{- 5} mol \text{/} L\end{matrix}$$

By now using the following simultaneous equations, the amount of stabiliser formulation can be determined:

### Sample 1:

10^{-2.53} mol/L=1.92 g of stabiliser formulation

### Sample 2:

10⁻⁵ mol/L=Xg of stabiliser formulation
∴ Xg(10^{-2.53} mol/L)=1.92 g(10⁻⁵ mol/L)
∴ X=0.00650581 g of stabiliser formulation

Accordingly, a minimum of 0.00650581 g of stabiliser formulation is required.

Stabiliser/L=1.92[10^{(2.53)-(pH)}] where pH is the initial acidity of the solution to be stabilised at standard temperature and pressure to form the stabilised acid component. This simplified formula can be used as a guide to dose the correct proportion of stabiliser to acid, although a physical test is recommended to check for zero additional foam being expelled from the solution as well as to test for dissolved phosphates.

Whilst this formula is linear and ideal for strong acids where it ionises totally in solution, it can also be used for weak acids, such as citric acid, which does not ionise totally in solution. This can be achieved by knowing the pH of the acid solution in a one liter RTC (ready to consume) product before being stabilised. Using the above formula to work out the stabiliser required and multiplying it by the dilution ratio, the final stabiliser amount is then deduced.

As is explained below in example 3 where the slurry concentrate dilution ratio is 1:10.609 to make 11.609 L RTC beverage and having a skim milk concentration of about 12% after dilution. The pH of the acid solution for making up a 1 litre RTC solution is 2.53 and using the above formula gives the required stabiliser of 1.92 g. Thereafter the stabiliser must be multiplied by the final volume of product to be made i.e. 11.609. Therefore the final amount of stabiliser required for adequate stabilisation would be 11.609×1.92 g=22.290 g. The reason for compensating for a weak acid is that whilst the product is being diluted, part of the hydrogen ions that were bonded ionically to the carboxyl groups will start to ionise in solution into hydronium ions and immediately will be attracted back electrostatically to the carboxyl group thereby maintaining equilibrium. However, if the compensated stabiliser is not added, then the solution will still want to reach equilibrium, but this time hydrogen ions will be released from the un-ionised acid, which is detrimental to the solution's stability, since this free unbound hydronium ions will dissolve the phosphate into solution, thereby causing the solution to sediment and flocculate.

2.5 g citric acid monohydrate per 1.92 g stabiliser formulation equates to 10^{-2.53} mol/L hydrogen ions per 1.92 g of stabiliser formulation used. Further, 10⁻⁵⁰ mol/L hydrogen ions per X amount of stabiliser is required. X accordingly equates to 0.00650581 g stabiliser formulation where the pH value of the acid base solution is 5. This number is useful in determining the minimum amount of stabiliser formulation required for producing carbonated milk drinks as carbonic acid will be formed during carbonation of the first stabiliser formulation 18.

Similarly, using the known amount of buffer required to buffer the solution during the drying process, the amount H⁺ ions removed from the carboxyl bonds to bond with anions of the buffer can be calculated. This number would be useful in confirming the minimum amount of buffer required during the drying process. It must be noted that the amount of buffer needed will also be dependent on how gentle the drying process is carried out.

The above calculation method can be used in determining whether additional buffer is required during a pasteurizing process. Persons skilled in the art will be aware of the fact that the pH value of a solution will decrease when the solution is heated.

In summary, the amount of the first stabiliser formulation 18 of the stabilised acid component 20 must be of a sufficient amount to deter the occurrence of any unbound hydrogen ions in the stabilised acid component 20. Similarly, the amount of second stabiliser formulation 12 in the stabilised protein component 14 must be of a sufficient amount to deter hydrogen ions becoming unbound from the stabilised acid component 20 and being attracted to the protein micelles in the acidified protein component 22.

While this invention is intended to address the problems encountered with undenatured milk proteins, it must be noted that other proteins or protein hydrolysates could work equally well using the above processes if sufficient steps are taken to modify the protein into a protein micelle. Also, while the above embodiment uses citric acid monohydrate, it is pointed out that other acids, as well as acids containing fruit content, can be used as long as suitable steps are taken for accurately determining the amount of stabiliser formulation required relative to the amount of hydrogen ion concentration in the acid 16 solution. This can be calculated readily by a person skilled in the art employing the above pH calculations as a guide.

It is further pointed out that products resulting from the above method could be fortified with vitamins, minerals, prebiotics and probiotics. The products could also include preservatives. Examples of preservatives which could be used include sodium benzoate, potassium sorbate and pimaricin.

Other buffers could of course also be employed. Examples of such buffers include potassium phosphate, sodium lactate and sodium acetate.

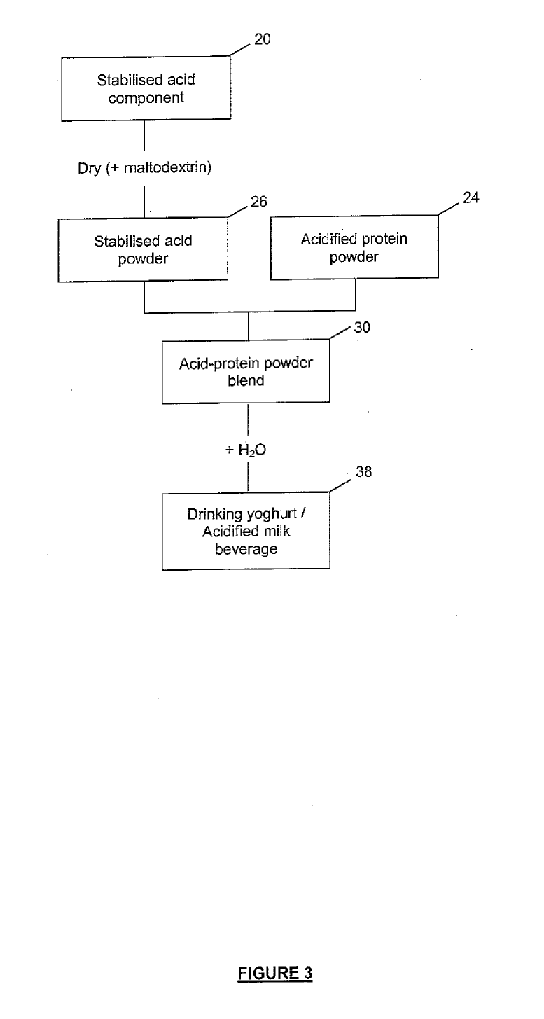

FIGS. 3-6 of the drawings provides diagrammatic representations of the steps to be taken in producing acid stable protein products by means of a number of variations of the claimed method. Typical products which can be produced according to the invention are protein beverages with different protein and pH levels and viscosities, for example low pH milk beverages, drinkable yoghurt style beverages, as well as cream cheeses without whey separation and fruit smoothies with milk proteins.

FIG. 3 discloses an alternative method of producing a yoghurt style beverage or an acidified milk beverage. The method comprises the steps of mixing a stabilised acid component 20 with a bulking agent in the form of maltodextrin, and spray drying the blend to provide a stabilised acid powder 26. The method then provides blending the stabilised acid powder 26 with the acidified protein powder 24, as described above, to form an acid-protein powder blend 30. The acid-protein powder blend 30 is then merely added to water to form a drinkable yoghurt style beverage or a milk juice type of beverage 38.

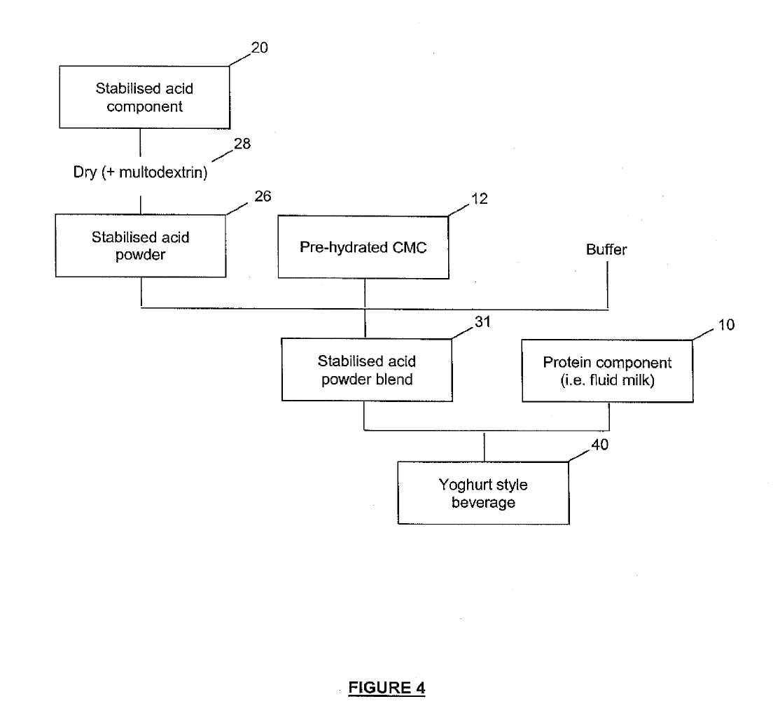

FIG. 4 illustrates yet another method of producing a yoghurt style beverage. It provides the steps of mixing a stabilised acid component 20 with a bulking agent in the form of maltodextrin 28, and spray drying the blend to provide a stabilised acid powder 26, similar to the method in FIG. 3, and then blending it with a powdered pre-hydrated CMC 12 and a buffer to produce a stabilised acid-powder blend 31. The stabilised acid-powder blend 31 is added to a liquid protein component 10 to produce the yoghurt style beverage 40.

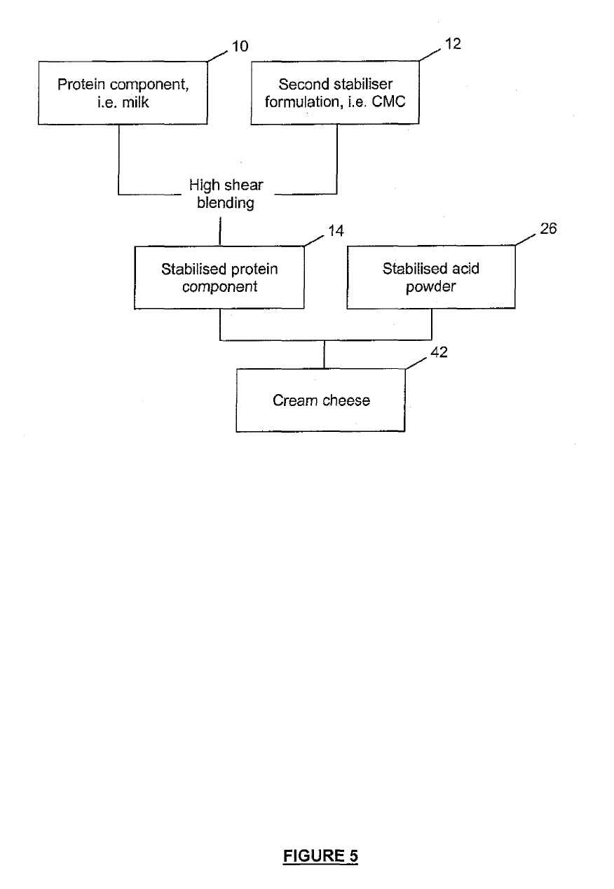

FIG. 5 illustrates a method of producing cream cheese according to the invention. The method provides the steps of adding a second stabiliser formulation 12 in the form of CMC to a protein component 10 in the form of milk, milk protein concentrate or milk protein isolate, and blending the two under high shear conditions to form a stabilised protein component 14. The stabilised acid powder 26 is then blended into the stabilised protein component 14 to produce cream cheese 42.

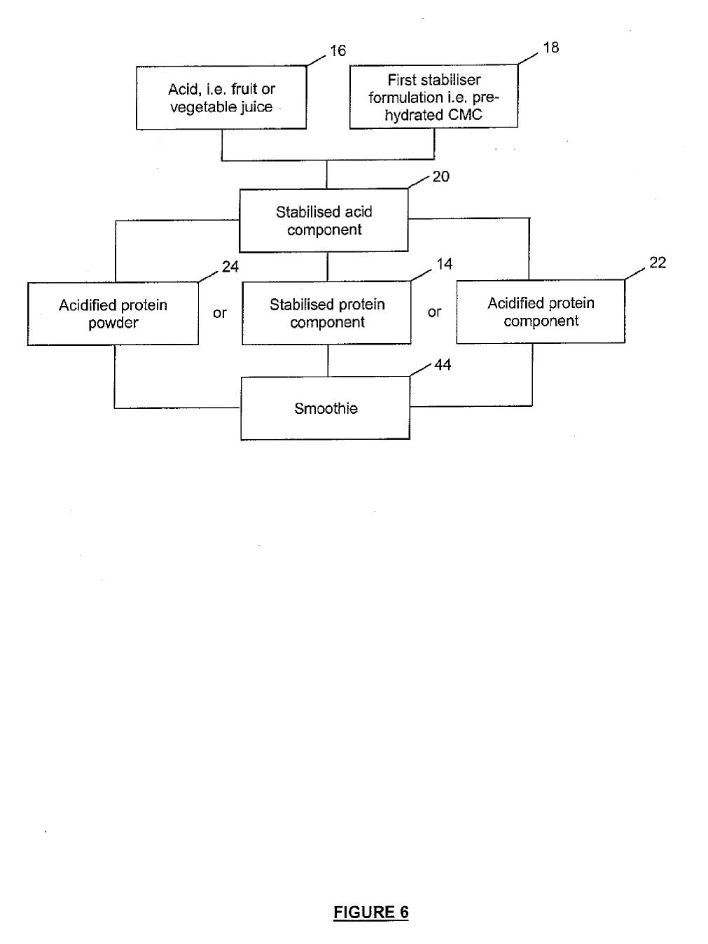

FIG. 6 illustrates a method of producing a smoothie. The method comprises the steps of providing an acid 16 in the form of fruit or vegetable juice or a combination thereof. To the acid 16 is added a first stabiliser formulation 18 in the form of pre-hydrated CMC, so as to produce a stabilised acid component 20. The acidified protein powder 24 or an acidified protein component 22 or a stabilised protein component 14 is then added to the stabilised acid component 20 to produce the smoothie 44.

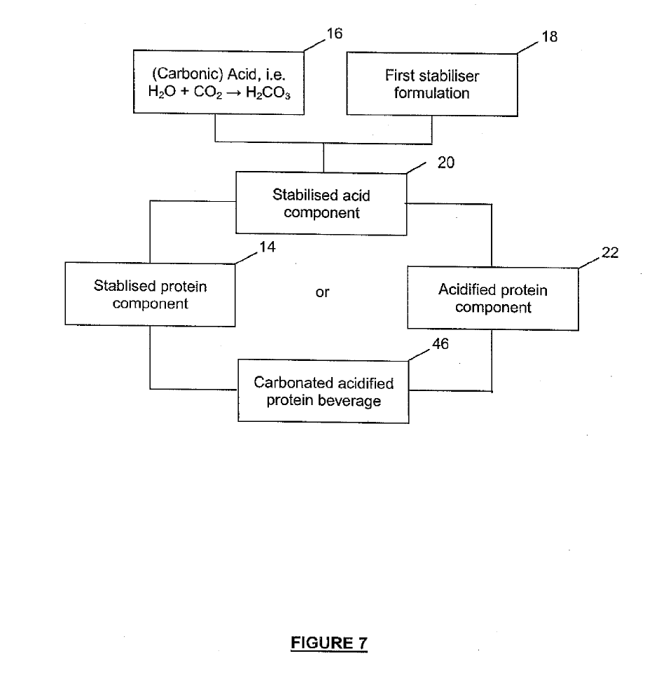

FIG. 7 illustrates a method of producing a carbonated protein beverage according to the invention. The method provides the steps of blending a first stabiliser formulation 18 into water and then introducing carbon dioxide into this mixture to produce a stabilised acid component 20. A stabilised protein component 14 is produced by mixing a second stabiliser formulation 12 with a protein 10, dissolved in water, and homogenising this mixture. The stabilised, protein component 14 is introduced into the stabilised (carbonated) acid component 20 to form a carbonated acidified protein beverage 46. The carbonated acidified protein beverage 46 may undergo homogenisation.

In an alternative method to that disclosed above, an acidified protein component 22 is introduced directly into the stabilised (carbonated) acid component 20 to form a carbonated acidified protein beverage 46.

It is important that the amount of stabiliser formulation must be sufficient to deter the occurrence of any unbound hydrogen ions which may occur as a result of the carbonating step.

Although not specifically described above, an alcohol may be added to the acid stable protein products formed by the above described methods.

Whilst the method explains production of acidified milk products using direct acidification by the use of food acids, it must be noted that products having similar organoleptic properties can also be produced, by using indirect acidification of milk, by using starter cultures, if sufficient steps are taken to produce such products. An example would be during ultra-filtration of milk, where the lactose containing component or permeate can be inoculated with a starter culture to produce lactic acid to the desired pH. This solution can then be blended under high shear with a pre-hydrated CMC or a dissolved CMC solution until no unbound hydrogen ions is available. This acid component can then be blended with the remaining protein component or retentate, which has been stabilised to form a yoghurt beverage with no whey separation. It must also be noted that this yoghurt beverage will not have the chalkiness that is associated with traditional yoghurts.

The invention will be exemplified further in the following examples.

### Example 1

### For Preparing about 1000 ml Ready-to-Drink Beverage

Acidified milk drink—containing about 120 g skimmed milk per litre or 12% skim milk.

Preferred pH value between 3.9 to 4.2

| | Stabilised | Stabilised Acid | Acidified |
|---|---|---|---|
| | protein | Component | Protein |
| Ingredients (kg) | component (kg) | (kg) | component (kg) |
| Anti-foam | | | 0.00043 |
| (Silfoamex 212F 20%) | | | |
| Skimmed Milk Powder | 0.012000 | | |
| (+−34% protein) | | | |
| CMC (Cekol 30) | 0.000480 | 0.001920 | |
| Citric Acid | | 0.002500 | |
| Monohydrate | | | |
| Tri Sodium Citrate | 0.000375 | | |
| Sucrose | | 0.115000 | |
| Water | 0.450000 | 0.450000 | |

Step 1: Preparing the Stabilised Protein Component
1.1 Dry-blend the 12 g of skimmed milk powder with the 0.48 g of CMC, then add the blend to the water under high shear. Add the 0.375 g tri-sodium citrate to the solution and blend well.
1.2 Allow to hydrate and de-foam for at least 30 minutes.
1.3 Can optionally be homogenized before addition of the tri-sodium citrate.

Step 2: Preparing the Acid Component
2.1 Dry-blend the 1.92 g CMC and 10 g sucrose. Add the dry-blend into the 450 g of water under high shear, wait for the gum to be fully hydrated, and then add the 2.5 g citric acid to the solution and blend well.
2.2 Allow to hydrate and de-foam, preferably not more than 60 minutes.
2.3 Can optionally be homogenized.

Step 3: Combine the products of step 1 and step 2 under high shear. At this stage the balance of the 105 g sucrose, colorants and flavorants can be added in. Optionally homogenize between 100-200 bar in either one or two stages. Anti-foam can be added at this stage.

Step 4: Pasteurize and fill into containers to cool down.

### Example 2

### For Preparing about 1000 ml Ready-to-Drink Beverage

Acidified milk drink—containing about 1000 g skimmed milk per litre similar to drinking yoghurt without the chalkiness.

Preferred pH value between 4.1 and 4.3.

| | Stabilised | Stabilised Acid | Acidified |
|---|---|---|---|
| | Protein | Component | Protein |
| Ingredients (kg) | component (kg) | (kg) | component (kg) |
| Anti-foam | | | 0.003583 |
| (Silfoamex 212F 20%) | | | |
| Skimmed Milk Powder | 0.100000 | | |
| (+−34% protein) | | | |
| CMC (Cekol 30) | 0.004000 | 0.005376 | |
| Citric Acid | | 0.007000 | |
| Monohydrate | | | |
| Tri Sodium Citrate | 0.00105 | | |
| Sucrose (Granular) | | 0.100000 | |
| Water | 0.450000 | 0.400000 | |

Step 1: Preparing the Stabilised Protein Component
1.1 Dry-blend the 100 g of skimmed milk powder with the 4 g of CMC, then add the blend to the 450 g water under high shear. Then add the 1.05 g tri-sodium citrate to the solution and blend well.
1.2 Allow hydrating and de-foaming for at least 30 minutes, or optionally pass the slurry through a de-aerator.
1.3 Can optionally be homogenized.

Step 2: Preparing the Acid Component
2.1 Dry-blend the 5.376 g CMC and 25 g sucrose. Add the dry-blend into the 450 g of water under high shear and allow the gum to completely hydrate, and then add the 7 g citric acid monohydrate to the solution and blend well.
2.2 Can optionally be homogenized.
2.3 Allow hydrating and de-foaming, preferably for not more than 60 minutes.

Step 3: Combine the products of step 1 and step 2 under high shear. At this stage the balance of the 75 g sucrose, colorants and flavorants can be added in. Optionally, homogenize between 100-200 bar in either one or two stages and then optionally pass the slurry through a de-aerator. Anti-foam may be added at this stage.

Step 4: Pasteurize and fill into containers to cool down.

### Example 3

### For Preparing about 1000 g Slurry for Spray Drying

Acidified milk slurry—containing about +−20% total solids

| | Stabilised | Stabilised Acid | Acidified |
|---|---|---|---|
| | Protein | Component | Protein |
| Ingredients(kg) | component (kg) | (kg) | component (kg) |
| Anti-foam | | | 0.005000 |
| (Silfoamex 212F 20%) | | | |
| Skimmed Milk Powder | 0.139316 | | |
| (+−34% protein) | | | |
| CMC (Cekol 30) | 0.005572 | 0.022290 | |
| Citric Acid | | 0.029024 | |
| Monohydrate | | | |
| Tri-Sodium Citrate | 0.004353 | | |
| Water | 0.252897 | 0.542983 | |

Step 1: Preparing Stabilised protein component 14
1.1 Dry-blend the 139.316 g of skimmed milk powder with the 5.572 g of CMC, into the 252.897 g of water under high shear. Then mix the 4.353 g of tri-sodium citrate in and blend well.
1.2 Allow hydrating and de-foaming for at least 30 minutes, or optionally pass the slurry through a de-aerator.
1.3 Preferably the slurry should be homogenized in one or two stages.

Step 2: Preparing the Acid Component
2.1 Add the 22.29 g of CMC into the 542.983 g of water under high shear, and then add the citric acid to the solution and blend well.
2.2 Can optionally be homogenized.
2.3 Allow hydrating and de-foaming, preferably for not more than 60 minutes.

Step 3: Combine the products of step 1 into step 2 under high shear. Optionally homogenize in either one or two stages and then preferably pass the slurry through a de-aerator. Anti-foam may be added at this stage.

Step 4: Spray dry between 150° C. to 160° C. until the moisture content is from 10% to 12.5%, although it is preferred to spray dry at 110° C. first stage and then to cool to the appropriate moisture content of 10% to 12.5% using fluidized beds.

Preservatives may be added to the acid protein base mixture if required. The slurry of step 3 may contain higher total solids depending on the viscosity that the spray dryer can handle and also the blending equipment.

Stored product life should keep up to twelve months or more. Dried powder can be dry-blended with sugar, sweeteners or a combination thereof, flavorants and colorants to prepare a powdered beverage to be added to water.

Dry-blend about 20 g of the spray dried powder with 115 g granular sucrose with flavorants and colorants to make a powdered soft drink blend. Mix this blend with 900 ml of water to make about 1 litre of beverage having a pH about 3.9.

### Example 4

### For preparing about 1000 g Fruit Bar Style—Real Fruit Smoothie)

Real Fruit Smoothie—containing about 100 g skimmed milk powder and 700 g Freshly Pureed Fruit per 1000 g

| | Stabilised Protein | Stabilised Acid |
|---|---|---|
| Ingredients (kg) | component (kg) | component (kg) |
| Anti-foam Silfoamex 212F 20%) | | |
| (optional) | | |
| Skimmed Milk Powder | 0.100000 | |
| (+−34% protein) | | |
| CMC (Cekol 30) | 0.004000 | |
| Pureed Real Fruit | | 0.700000 |
| Pre-Hydrated Ticalose CMC 15 | | 0.001000 |
| (Dose is pH dependant) | | |
| Sucrose or other Sweetener | | |
| (Optional) | | |
| Tri-Sodium Citrate (Optional) | | |
| Water | 0.300000 | |

Step 1: Preparing the Stabilised Protein Component
1.1 Dry-blend the 100 g of skimmed milk powder with the 4 g of Cekol 30 CMC and then add the blend to the water under high shear and optionally adding tri-sodium citrate to the blend.
1.2 Allow to hydrate for at least 30 minutes.

Step 2: Preparing the Acid Component
2.1 Add the 1 g pre-hydrated CMC 15 powder to the 700 g of fruit puree under high shear and allow the gum to completely hydrate.

Step 3: Combine the products of step 1 and step 2 under high shear.

Product is ready.

The stabilised protein component could be substituted with a low pH high protein content spray dried acidified protein powder of about 50 g and then added to 950 g of fruit puree. Then there is no 30 minute hydrating time for the stabilised protein component. For a lactose reduced recipe, the skim milk can be substituted with milk protein isolate.

### Example 5

### Stabilised Acid-Powder for Preparing about 1000 g Drinking Yoghurt Type Beverage

Slurry—containing about +−15% total solids.

| | Flavor | Stabilised Acid |
|---|---|---|
| Ingredients(kg) | Component (kg) | Powder (kg) |
| Anti-foam (Silfoamex 212F 20%) | | 0.023714 |
| Maltodextrin | | 0.087680 |
| CMC (Cekol 30) | | 0.058453 |
| Pre-Hydrated Ticalose CMC 15 | 0.004000 | |
| Citric Acid Monohydrate | | 0.076111 |
| Tri-Sodium Citrate | 0.001150 | 0.007611 |
| Sucrose (fine granular) | 0.100000 | |
| Flavorant (Strawberry) | 0.001000 | |
| Colorant (Allura Red) | 0.000050 | |
| Water | | 1.246430 |

Step 1: Preparing the Acid Powder Component
1.1 Mix the anti-foam into the 1246.430 g of water (optional).
1.2 Mix the stabiliser i.e. Cekol 30, into the water under high shear.
1.3 Allow mixture to hydrate completely.
1.4 Add the acid under high shear to the stabiliser mixture until completely dissolved.
1.5 Add the maltodextrin to the acidified mixture under high shear. Optionally the maltodextrin could be blended with the Cekol 30 and dissolved into the water as per 1.2
1.6 Spray-dry this mixture between 120° C. to 150° C. having a moisture content of 10% to 15%. Spray drying must be done within one hour of acidification. Pre-measure30.2 g of this powder.

Step 2: Preparing the Flavor Component
2.1 Dry-blend all the ingredients of the flavor component.

Step 3: Combine the pre-measured acid powder of step 1 into step 2 and blend well. A free flow agent like Sipernat (silicon dioxide) can be used.

Step 4: Mix the powder of step 3 with one litre of fluid milk to make a drinking yoghurt style beverage. If solubility is a problem the Silfoamex in the acid component can be reduced below 23.714 g

### Example 6

### For Preparing about 1000 Ml of Carbonated and Acidified Milk Drink

Carbonated and Acidified Milk Drink—Containing about 120 g of Skimmed Milk

| | First Stabiliser Acid |
|---|---|
| Ingredients (kg) | Component (kg) |
| Acidified Protein Component | 0.086135 |
| Example: 3 (reduced pH Formula) | |
| Liquid Sugar (about 70% Brix) | 0.017142 |
| CMC (Cekol 30) | 0.000500 |
| Water | 0.896723 |

Step 1: Preparing the Stabiliser Component Mix 0.5 g Cekol 30 with the 896.723 g of water under high shear conditions until completely dissolved. Mixture should be free of air bubbles by using a vacuum system. The holding vessel should then be pressurized with CO₂. The mixture can now be carbonated to normal levels of carbonated soda drinks i.e. ±four volumes of CO₂ gas. While under pressure the mixture should be mixed under high shear. The mixture may optionally be left to rest until all CO₂ is dissolved into solution. The acidified milk component, which must be free of trapped air, and the liquid sugar, containing flavorants and colorants, can be pumped into the carbonated stabiliser mixture under high shear. The mixture may optionally be left to rest until all the CO₂ is dissolved into solution. The mixture may contain anti-foaming agents.

### Step 2: Homogenizing the Mixture

The carbonated protein beverage may now be transferred to another vessel that is pressurized with CO₂. A homogenizer should be placed between both the vessels. The product is now pumped via the homogenizer into the other vessel pressurized with CO₂. This mixture can be homogenized between 100 bar and 200 bar using a one or two stage homogenizing cycle. The carbonated mixture is allowed to settle in the other vessel until all the CO₂ is dissolved into solution. The carbonated beverage can now be pressure filled into containers. Normal pasteurization procedures can be followed. The mixture may include anti-foaming agents.

### Example 7

### For Preparing about 1000 ml of Carbonated Milk Drink

Carbonated Milk Drink—Containing about 1000 g of Skimmed Milk

| | First Stabilised | |
|---|---|---|
| | Acid Component | Stabilised Protein |
| Ingredients (kg) | (kg) | Component 14 (kg) |
| Antifoam (Silfoamex 212F 20%) | | 0.003583 |
| Skimmed Milk Powder | | 0.100000 |
| (+−34% protein) | | |
| Liquid Sugar (about 70% Brix) | 0.017142 | |
| CMC (Cekol 30) | 0.000500 | 0.004000 |
| Water | 0.675000 | 0.225000 |

### Step 1: Preparing the Carbonated Protein Beverage

Mix 0.5 g Cekol 30 with the 675.000 g of water under high shear conditions until completely dissolved. The mixture must be free of air bubbles by using a vacuum system. The holding vessel is then pressurized with CO₂. The mixture is now carbonated to the conventional levels of carbonated soda drinks i.e. ±four volumes of CO₂ gas. While under pressure the mixture is mixed under high shear conditions. The mixture may optionally be left to rest until all the CO₂ has dissolved into solution. The prepared stabilised protein component, after being mixed by high shear and thereafter homogenized and a buffer added to it, must be free of trapped air, and is pumped into the carbonated stabiliser mixture under high shear followed by the liquid sugar, flavorants and colorants. The mixture may optionally be left to settle until all the CO₂ has dissolved into solution.

Step 2: Homogenizing the Mixture.

The carbonated acidified protein beverage may now be transferred into another vessel which is pressurized with CO₂. A homogenizer is placed between both vessels. The formed product is pumped via the homogenizer into the other vessel pressurized with CO₂. This mixture is homogenized between 100 bar and 200 bar using a one or two stage homogenizing cycle. The carbonated mixture is left to settle in the other vessel until all the CO₂ has dissolved into solution. The carbonated beverage is now pressure filled into containers. Normal pasteurization procedures can be followed.

Conversion: 1 bar=1×10⁵ Pa
Lab Equipment and Special ingredients Listing:

### Ingredients:

1. TIC—PRETESTED® Pre-Hydrated® Ticalose® CMC 15 Powder (Manufacturer:—TIC GUMS).
2. CP Kelco—CEKOL 30 Sodium Carboxymethylcellulose (Manufacturer: Cp Kelco)
3. Silfoamex 212F 20% Anti-foam-Dimethylsiloxane emulsion (Manufacturer: Chemserve South Africa)

### Lab Equipment:

1. Silverson L4RT High Shear Laboratory Mixer
2. AnD MX-50 Moisture Analyzer
3. IQ Scientific pH Meters
4. BÜCHI Mini Spray Dryer—Model B-290
5. Soda Stream Premium Carbonating Machine
6. Customized Self Constructed Vacuum Chamber
7. Customized Self Constructed Fluid Bed Processor
8. Customized Self Constructed Large Spray Drying Chamber for bigger particle size.

| Citric Acid | | | | |
|---|---|---|---|---|
| Monohydrate (g) | | Volume (ml) | pH | |
| 2.50 | | 1000 | 2.5 | |
| 5.00 | | 1000 | 2.5 | |
| 7.50 | | 1000 | 2.4 | |
| 10.0 | | 1000 | 2.3 | |
| 12.5 | | 1000 | 2.2 | |
| Citric Acid | Cekol 30 CMC | | | Temperature |
| Monohydrate (g) | (g) | Volume (ml) | pH | ° C. |
| 2.50 | 0.00 | 1000 | 2.53 | 18.8 |
| 2.50 | 1.92 | 1000 | 3.07 | 18.9 |
| 2.50 | 3.84 | 1000 | 3.40 | 18.6 |
| 2.50 | 5.76 | 1000 | 3.65 | 19.70 |
| 2.50 | 7.68 | 1000 | 3.84 | 20.8 |
| 2.50 | 9.60 | 1000 | 3.97 | 21.90 |
| 2.50 | 0.00 | 1000 | 2.53 | 18.8 |
| 2.50 | 1.92 | 1000 | 2.94 | 19.1 |
| 5.00 | 3.84 | 1000 | 2.89 | 20.0 |
| 7.50 | 5.76 | 1000 | 2.88 | 19.8 |
| 10.00 | 7.68 | 1000 | 2.87 | 21.2 |
| 12.50 | 9.60 | 1000 | 2.87 | 22.9 |
| 64.92 | 49.86 | 1000 | 2.71 | 25.0 |

| | Skim milk | | | |
|---|---|---|---|---|
| Citric | Powder:Cekol | | | |
| Acid:Cekol | 30 | | | |
| 30 Blend | Blend ratio | | | Temperature |
| ratio (g) | (g) | Volume (ml) | pH | ° C. |
| 2.5:1.92 | 3:0.12 | 1000 | 3.25 | 19.4 |
| 2.5:1.92 | 6:0.24 | 1000 | 3.44 | 20.2 |
| 2.5:1.92 | 12:0.48 | 1000 | 3.67 | 18.2 |
| 2.5:1.92 | 24:0.96 | 1000 | 4.12 | 18.6 |
| 2.5:1.92 | 36:1.44 | 1000 | 4.41 | 19.7 |
| 2.5:1.92 | 48:1.92 | 1000 | 4.60 | 20.0 |
| 2.5:1.92 | 60:2.40 | 1000 | 4.82 | 20.5 |

1-106. (canceled)

107. A method of producing an acidified protein component, comprising the steps of:
providing a protein component in the form of an undenatured liquid or powder protein in micellar form;
providing a stabilised acid component comprising an acid and an amount of a first anionic stabiliser formulation dissolved in water, wherein the amount of first anionic stabiliser formulation that is added to the acid is calculated such that the number of anionic groups from the first anionic stabiliser formulation is greater than or equal to the number of dissociated hydrogen ions from the acid; and
blending the stabilised acid component with the protein component to form the acidified protein component,
the acidified protein component being characterized therein that the protein in the protein component maintains its negative charge and its micellar form after the stabilised acid component is blended with the protein component.

108. The method according to claim 107, wherein the protein in micellar form in the acidified protein component is colloidal in solution.

109. The method according to claim 107, wherein the stabilised acid component has a pH of more than 2.7.

110. The method according to claim 107, wherein the first stabiliser formulation comprises a hydrocolloid polysaccharide stabiliser gum.

111. The method according to claim 107, wherein the acid is a food-grade acid.

112. The method according to claim 107, wherein the undenatured liquid or powder protein is dissolved in water.

113. The method according to claim 107, wherein the protein component comprises milk based proteins.

114. The method according to claim 107, wherein the protein component comprises soy based proteins, which exist in micellar form with an organic salt or polyphosphate, and is colloidal in solution with a cation.

115. The method according to claim 107, wherein the protein component comprises a protein or a protein hydrolysate from a vegetable or an animal origin that is insoluble at its isoelectric point, exists in micellar form with an organic salt or polyphosphate, and is colloidal in solution with a cation.

116. The method according to claim 107, wherein the protein component is pre-mixed with an amount of a second stabiliser formulation that is dissolved in water or a liquid protein component so as to produce a stabilised protein component, before the stabilised protein component is blended with the stabilised acid component to form the acidified protein component, the method comprising calculating the ratio between the second stabiliser formulation and the protein component such that the amount of the second stabiliser formulation is sufficient to deter hydrogen ions from becoming unbound from the stabilised acid component and being attracted to protein micelles in the acidified protein component, thereby to achieve maximum precipitation of the protein micelles from the stabilised protein component.

117. The method according to claim 116, wherein the second stabiliser formulation is an anionic, hydrocolloid, polysaccharide stabiliser gum of low molecular weight.

118. The method according to claim 117, wherein the polysaccharide stabiliser gum includes carboxyl groups.

119. The method according to claim 116, wherein the ratio between the protein component and the second stabiliser formulation in the stabilised protein component is between 17:1 and 5.666:1.

120. The method according to claim 116, wherein the protein component and the second stabiliser formulation undergo high shear mixing, and wherein a buffer is blended into the stabilised protein component after the high shear mixing.

121. The method according to claim 116, wherein the stabilised acid component is blended with the stabilised protein component in deionized filtered water and within no more than 1 hour of the acid and dissolved first stabiliser formulation being added together.

122. The method according to claim 116, wherein the protein component is in the form of milk, milk protein concentrate or milk protein isolate, and wherein the second stabiliser formulation is in the form of CMC, and wherein the protein component is blended with the second stabiliser formulation under high shear conditions to form a stabilised protein component, and wherein the method includes the further step of blending the stabilised protein component with the stabilised acid powder to produce cream cheese, which includes its whey proteins.

123. The method according to claim 107, wherein the acidified protein component has a pH of between 3.1 and 6.5 whilst simultaneously maintaining the original negative charge and micellar form of the protein at below and above the protein's isoelectric point.

124. The method according to claim 107, wherein the acidified protein component is dried to form an acidified protein powder with a particle size of greater than 100 micrometers and a moisture content of between 5% and 15%.

125. The method according to claim 124, including the further steps of:
drying the stabilised acid component to form a stabilised acid powder, and
dry-blending the stabilised acid powder with the acidified protein powder to form an acid-protein powder blend.

126. The method according to claim 125, including the step of adding a bulking agent to the stabilised acid component before drying it, wherein the bulking agent is selected from the group comprising hydrolysed starches, sugars and maltodextrin.

127. The method according to claim 124, wherein either the acidified protein powder or the acid protein powder blend is added to water to form a yoghurt style beverage or a ready-to-drink acidified milk beverage.

128. The method according to claim 107, including the further steps of:
drying the stabilised acid component to form a stabilised acid powder,
dry-blending the stabilised acid powder with pre-hydrated CMC powder and a buffer to form a stabilised acid-powder blend, and
blending the stabilised acid-powder blend into a protein component,
the method including the step of encapsulating the stabilised acid powder, such that there is at least 10 seconds delay before the stabilised acid powder starts to dissolve, so as to allow the pre-hydrated CMC powder in the stabilised acid-powder blend to first dissolve into the protein component.

129. The method according to claim 107, wherein the stabilised acid component comprises an acid in the form of fruit or vegetable juice, and a first stabiliser formulation, in the form of pre-hydrated CMC powder, and wherein the stabilised acid component is blended with one of either an acidified protein component, stabilised protein component, or an acidified protein powder to form a smoothie that includes casein milk proteins.

130. The method according to claim 107, wherein the stabilised acid component is produced by introducing carbon dioxide into an amount of a first stabiliser formulation that has been dissolved in water, to form a carbonated stabilised acid component, and wherein the stabilised protein component or the acidified protein component is introduced into the carbonated stabilised acid component to form a carbonated acidified protein beverage.

131. The method according to claim 130, wherein the carbonated stabilised acid component has a pH exceeding 2.7.

132. A method of producing an acidified protein powder, comprising the steps of:
providing a stabilised acid component comprising an acid and an amount of a first anionic stabiliser formulation dissolved in water, wherein the amount of first anionic stabiliser formulation that is added to the acid is calculated such that the number of anionic groups from the first anionic stabiliser formulation is greater than or equal to the number of dissociated hydrogen ions from the acid;
providing a stabilised protein component comprising a protein component and a second stabiliser formulation dissolved in water, the amount of second stabiliser formulation being sufficient to deter hydrogen ions from becoming unbound from the stabilised acid component and being attracted to protein micelles in an acidified protein component;
blending the stabilised acid component with the stabilised protein component under high shear conditions to form an acidified protein component; and
drying the acidified protein component to form the acidified protein powder.

133. A method of producing a drinking style yoghurt beverage or a ready-to-drink acidified milk beverage comprising the steps of adding the acidified protein powder of claim 132 to water to form the drinking style yoghurt beverage or a ready-to-drink acidified milk beverage.

134. A method of producing a drinking style yoghurt beverage or a ready-to-drink acidified milk beverage, comprising the steps of:
providing a stabilised acid component comprising an acid and an amount of a first anionic stabiliser formulation dissolved in water, wherein the amount of first anionic stabiliser formulation that is added to the acid is calculated such that the number of anionic groups from the first anionic stabiliser formulation is greater than or equal to the number of dissociated hydrogen ions from the acid;
adding a bulking agent to the stabilised acid component;
drying the stabilised acid component to form a stabilised acid powder;
dry-blending the stabilised acid powder with the acidified protein powder of claim 132 to form an acid-protein powder blend; and
adding the acid-protein powder blend to water to form the drinking style yoghurt beverage or ready-to-drink acidified milk beverage.

135. A method of producing a yoghurt style beverage comprising the steps of:
providing a stabilised acid component comprising an acid and an amount of a first anionic stabiliser formulation dissolved in water, wherein the amount of first anionic stabiliser formulation that is added to the acid is calculated such that the number of anionic groups from the first anionic stabiliser formulation is greater than or equal to the number of dissociated hydrogen ions from the acid;
adding a bulking agent to the stabilised acid component;
drying the stabilised acid component to form a stabilised acid powder;
providing a first stabiliser formulation in the form of pre-hydrated CMC powder, the amount of first stabiliser formulation being sufficient to deter hydrogen ions from becoming unbound from the stabilised acid component and being attracted to protein micelles in an acidified protein component;
providing a protein component in the form of fluid milk;
blending the stabilised acid powder, the pre-hydrated CMC powder and a buffer to form a stabilised acid powder blend; and
blending the stabilised acid powder blend with a stabilised protein component to form a yoghurt style beverage.

136. A method of producing cream cheese comprising the steps of:
providing a stabilised acid component comprising an acid and an amount of a first anionic stabiliser formulation dissolved in water, wherein the amount of first anionic stabiliser formulation that is added to the acid is calculated such that the number of anionic groups from the first anionic stabiliser formulation is greater than or equal to the number of dissociated hydrogen ions from the acid;
adding a bulking agent to the stabilised acid component;
drying the stabilised acid component to form a stabilised acid powder;
providing a stabilised protein component comprising a protein component in the form of milk, milk protein concentrate or milk protein isolate and a second stabiliser formulation in the form of CMC dissolved in water, the amount of second stabiliser formulation being sufficient to deter hydrogen ions from becoming unbound from the stabilised acid component and being attracted to protein micelles in an acidified protein component, and blending the protein component and CMC under high shear conditions to form the stabilised protein component; and
blending the stabilised acid powder into the stabilised protein component to form the cream cheese.

137. A method of producing a smoothie comprising the steps of:
providing a stabilised acid component comprising an acid in the form of fruit or vegetable juice or combinations thereof, and an amount of a first anionic stabiliser formulation in the form of pre-hydrated CMC powder dissolved into the first anionic stabiliser formulation, wherein the amount of first anionic stabiliser formulation that is added to the acid is calculated such that the number of anionic groups from the first anionic stabiliser formulation is greater than or equal to the number of dissociated hydrogen ions from the acid; and
either blending the stabilised acid component with the acidified protein powder of claim 132 to form the smoothie; or
blending the stabilised acid component with a stabilised protein component comprising a protein component and a second stabiliser formulation dissolved in water, the amount of second stabiliser formulation being sufficient to deter hydrogen ions from becoming unbound from the stabilised acid component and being attracted to protein micelles in an acidified protein component to form the smoothie; or
blending the stabilised acid component with the acidified protein component of claim 132 to form the smoothie.

138. A method of producing a carbonated acidified protein beverage comprising the steps of:
providing a stabilised acid component that is produced by introducing carbon dioxide into an amount of a first stabiliser formulation that has been dissolved in water, to form a carbonated stabilised acid component; and
either blending the carbonated stabilised acid component with a stabilised protein component comprising a protein component and a second stabiliser formulation dissolved in water to form the carbonated acidified protein beverage; or
blending the carbonated stabilised acid component with an acidified protein component to form the carbonated acidified protein beverage.

139. A stabilised acid component comprising an acid and an amount of a first anionic stabiliser formulation dissolved in water, wherein the amount of the first anionic stabiliser formulation that is added to the acid is calculated such that the number of anionic groups from the first anionic stabiliser formulation is greater than or equal to the number of dissociated hydrogen ions from the acid.

140. A stabilised protein component comprising a protein component and an amount of a second stabiliser formulation dissolved in water or a liquid protein component, the amount of the second stabiliser formulation being sufficient to deter hydrogen ions from becoming unbound from the stabilised acid component of claim 139.

141. An acidified protein component comprising:
a stabilised acid component comprising an acid and an amount of a first anionic stabiliser formulation dissolved in water, wherein the amount of first anionic stabiliser formulation that is added to the acid is calculated such that the number of anionic groups from the first anionic stabiliser formulation is greater than or equal to the number of dissociated hydrogen ions from the acid; blended with
a stabilised protein component comprising a protein component and an amount of a second stabiliser formulation dissolved in water or a liquid protein component, the amount of the second stabiliser formulation being sufficient to deter hydrogen ions from becoming unbound from the stabilised acid component.
